(19) United States
(12) Patent Application Publication
(10) Pub. No.: US 2025/0121371 A1
(43) Pub. Date: Apr. 17, 2025

(54) HIGH-SPEED BEAD HANDLING SYSTEM AND METHOD

(71) Applicant: Kinematic Automation, Inc., Sonora, CA (US)

(72) Inventors: Theodore V. Meigs, Sonora, CA (US); Robert J. Munoz, Sonora, CA (US)

(21) Appl. No.: 18/918,544

(22) Filed: Oct. 17, 2024

Related U.S. Application Data
(60) Provisional application No. 63/590,971, filed on Oct. 17, 2023.

(51) Int. Cl. B01L 3/00; B25J 9/04; B25J 15/06

(52) U.S. Cl. CPC B01L 3/502761; B25J 9/042; B25J 15/0616; B01L 2200/0647

(57) ABSTRACT

A bead handling system comprises a first lift assembly and a second lift assembly that each comprise an actuator and at least one vacuum tube for selectively engaging with a bead, such as a lyophilized bead. The actuators are configured to extend and retract their respective vacuum tubes for selective engagement with beads and selective positioning of the engaged beads into known positions. The actuators of the first and second lift assemblies may be extended and retracted oppositely from one another. Still further, the vacuum tube of each of the first and second lift assemblies may engage a bead when retracted, and position an engaged bead into a known position when in the extended position.

### CROSS REFERENCE TO RELATED APPLICATION

The present application claims the priority benefit of U.S. provisional patent application Ser. No. 63/590,971, filed on Oct. 17, 2023, which is incorporated herein by reference in its entirety.

### FIELD OF THE INVENTION

The present invention is directed to a handling system for beads, and in particular to an improved system for high-speed multi-bead handling, such as may be used for handling lyophilized beads.

### BACKGROUND OF THE INVENTION

Various products or components are formed in spherical bead shapes, including metal, plastic and other beads. One such bead shaped product are lyophilized beads that are spheres of material, such as assays or reagents, that have been lyophilized, such as from which water has been removed so as to preserve the materials, extend their shelf life and/or improve the material handling ability of the materials. For example, lyophilized beads may be formed through the instant freezing of a liquid formation, such as via liquid nitrogen, and then freeze drying the material. The lyophilized beads then result in a material formation that is consistent in size and dry for storage and/or material handling and that can later be reconstituted for use. Lyophilized beads can have diameters in the range of 0.5 mm or less and up to 1.8 mm to 3.5 mm, or larger including up to 6 mm.

### SUMMARY OF THE INVENTION

The present invention provides a bead handling system, and in particular a high-speed multi-bead handling system, such as may be used for lyophilized beads.

According to an aspect of the present invention, a bead handling system comprises at least a first lift assembly and a second lift assembly, wherein each of the first and second lift assemblies comprise an actuator and at least one vacuum tube for selectively engaging with a bead, where the actuators of the first and second lift assemblies are configured to extend and retract their respective vacuum tube for selective engagement with a bead and selective positioning of the engaged bead into a known position, and wherein the actuators of the first and second lift assemblies are not simultaneously extended and retracted together in unison.

According to a further aspect of the present invention, a lyophilized bead handling system comprises a first lift assembly and a second lift assembly that each comprise an actuator and at least one vacuum tube for selectively engaging with a lyophilized bead. The actuators of the first and second lift assemblies are configured to extend and retract their respective vacuum tube for selective engagement with a lyophilized bead and selective positioning of the engaged lyophilized bead into a known position, where the actuators of the first and second lift assemblies are not simultaneously extended and retracted together in unison. In accordance with a particular embodiment, the actuators of the first and second lift assemblies are extended and retracted oppositely from one another. Still further, the vacuum tube of each of the first and second lift assemblies may engage a lyophilized bead when retracted, and position an engaged lyophilized bead into a known position when in the extended position.

In accordance with particular embodiments, each of the first and second lift assemblies comprise a plurality of vacuum tubes. Still further, the system comprises a container for lyophilized beads, where the vacuum tube of the first lift assembly is configured to extend from an internal volume of the container and retract into the internal volume of the container. Correspondingly, the vacuum tube of the first second lift assembly is configured to extend from the internal volume of the container and retract into the internal volume of the container. In a particular configuration the actuators of the first and second lift assemblies are disposed beneath the container, where the actuators of the first and second lift assemblies are configured to vertically extend and retract their respective vacuum tubes.

In accordance with another aspect of the present invention, a method of handling lyophilized beads using a material handling system having a first actuator coupled with at least one vacuum tube and a second actuator coupled with at least one vacuum tube comprises extending and retracting the first actuator to selectively engage a lyophilized bead with the tube coupled to the first actuator and selectively position the engaged lyophilized bead into a known position, and correspondingly extending and retracting the second actuator to selectively engage a lyophilized bead with the tube coupled to the second actuator and selectively position the engaged lyophilized bead into a known position, where the actuators of the first and second lift assemblies are not simultaneously extended and retracted together in unison. In a particular configuration the method comprises extending and retracting the first and second actuators oppositely from one another.

In accordance with a particular embodiment, the vacuum tube coupled to each of the first and second actuators engages a lyophilized bead when retracted, and wherein the vacuum tube coupled to each of the first and second actuators positions an engaged lyophilized bead into a known position when in the extended position. Still further, the system may include a plurality of vacuum tubes coupled to each of the first and second actuators. The system further comprises a container for lyophilized beads, where the vacuum tube coupled to the first actuator is configured to extend from an internal volume of the container and retract into the internal volume of the container, and correspondingly the vacuum tube coupled to the second actuator is configured to extend from the internal volume of the container and retract into the internal volume of the container. In such a configuration the first and second actuators are disposed beneath the container.

The lyophilized bead handling system of the present invention enables a steady supply of lyophilized beads to be supplied, such as to another material handling component, such as a pick-and-place device. The present system may operate as a high-speed multi-bead handling system utilizing multiple vacuum tubes disposed on each of a plurality of lift assemblies to selectively engage beads from a container and position the beads for grasping by the pick-and-place device. These and other objects, advantages, purposes and features of this invention will become apparent upon review of the following specification in conjunction with the drawings.

### BRIEF DESCRIPTION OF THE DRAWINGS

FIG. 1A is a front left side perspective view of an embodiment of a high-speed bead material handling system constructed as a lyophilized bead handling system in accordance with aspects of the present invention;

FIG. 1B is a front right side perspective view of the system of FIG. 1A;

FIG. 1C is a rear right side perspective view of the system of FIG. 1A;

FIG. 1D is a front top perspective view of the system of FIG. 1A;

FIG. 1E is a partial close-up rear left side perspective view of the system of FIG. 1A;

FIG. 2A is a rear perspective view of a bead lifting assembly shown apart from the system of FIG. 1A;

FIG. 2B is a front perspective view of the bead lifting assembly of FIG. 2A with a front portion removed for clarity;

FIG. 2C is a rear elevation view of the bead lifting assembly of FIG. 2A;

FIG. 2D is a rear elevation view of the bead lifting assembly of FIG. 2A shown with one of the lifting heads in a retracted orientation;

FIG. 3A is a top perspective view of a bead container shown apart from the bead lifting assembly of FIG. 2A;

FIG. 3B is a lower perspective view of the bead container of FIG. 3A;

FIG. 4 is a perspective view of a guide of one of the lifting heads shown apart from the bead lifting assembly of FIG. 2A;

FIG. 5A is a side perspective view of a bead feeder shown apart from the system of FIG. 1A;

FIG. 5B is a front perspective view of the bead feeder of FIG. 5A;

FIG. 6 is a perspective view of a bead handler shown apart from the system of FIG. 1A;

FIG. 7 is a perspective view of a conveyor station for use with the system of FIG. 1A according to aspects of the present invention; and

FIGS. 8 and 9 are perspective views of trays for use with the conveyor station of FIG. 7.

### DESCRIPTION OF THE PREFERRED EMBODIMENTS

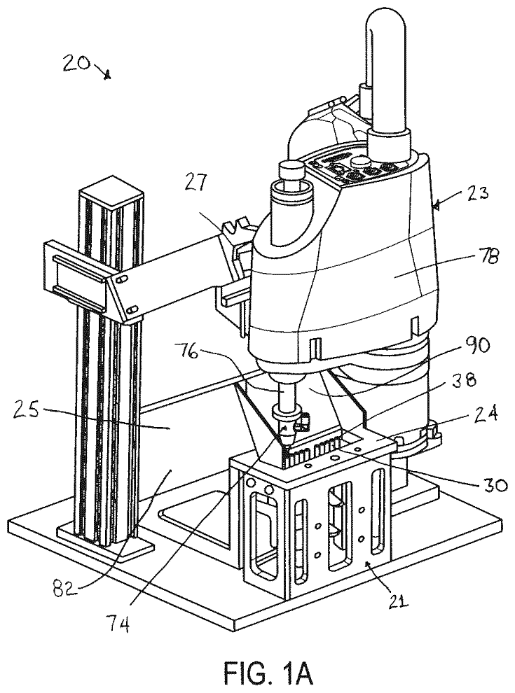

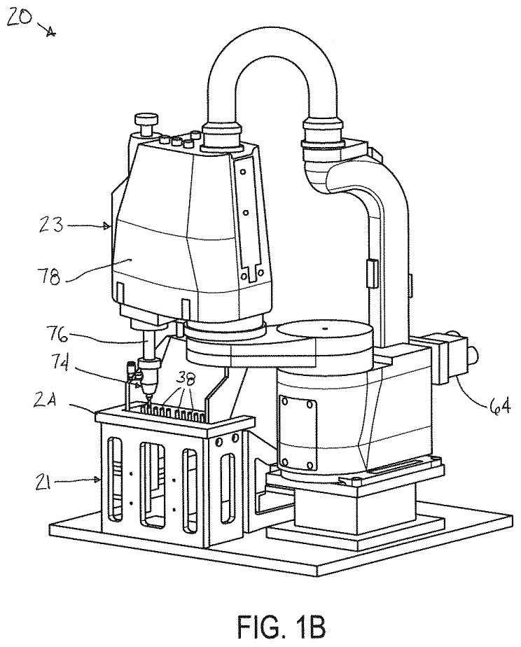

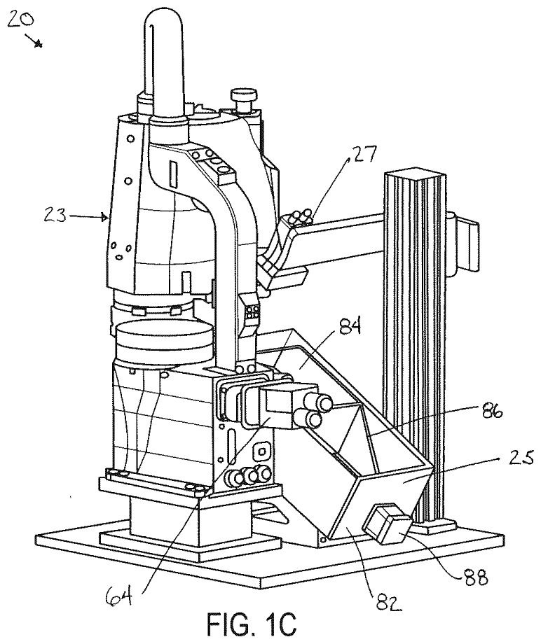

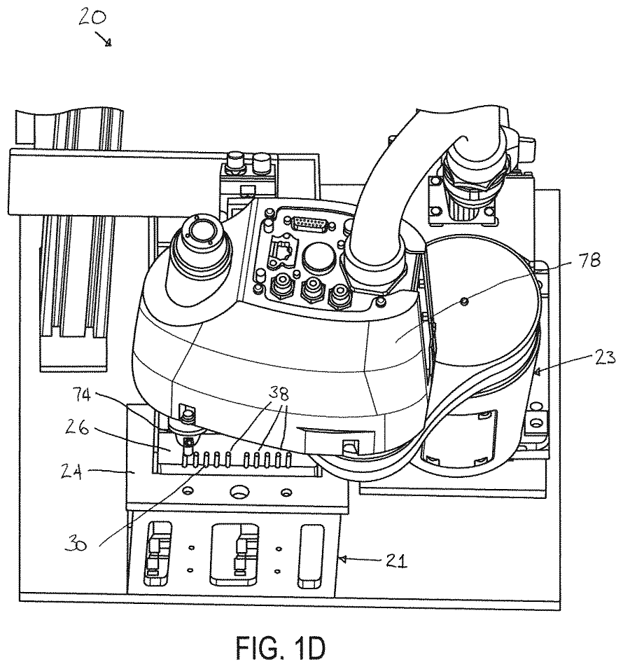

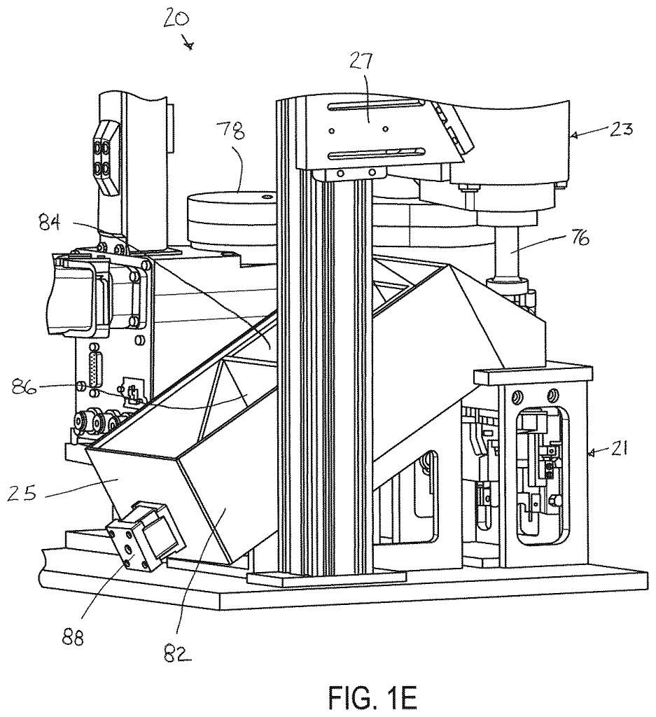

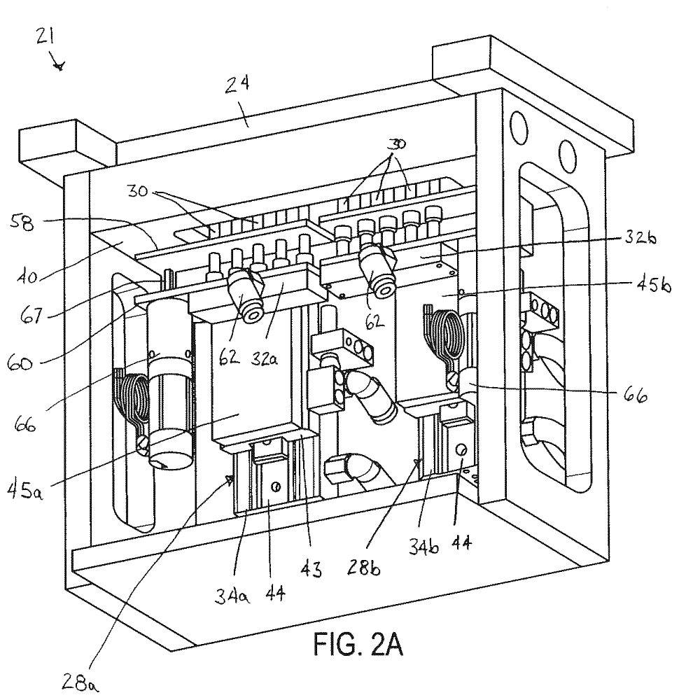

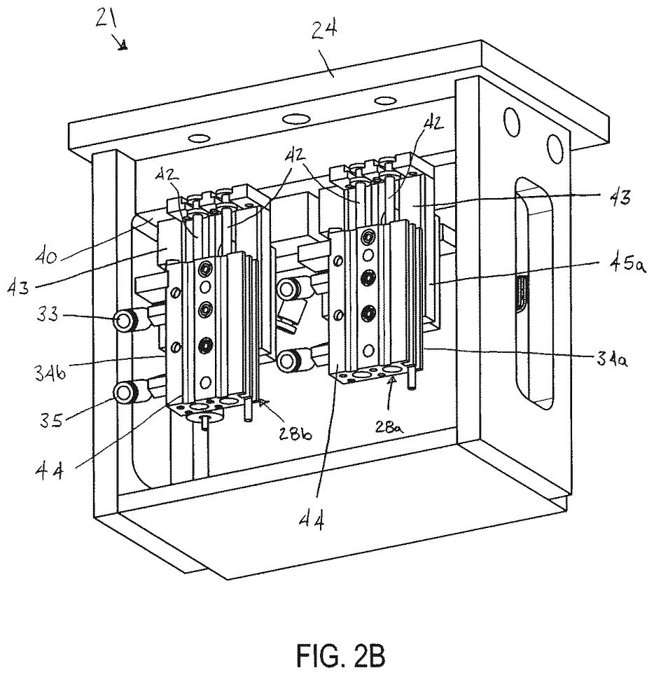

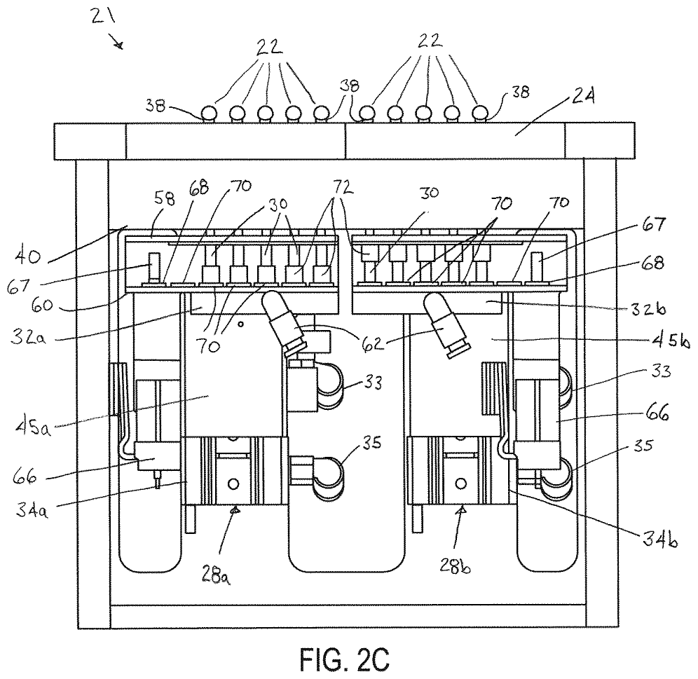

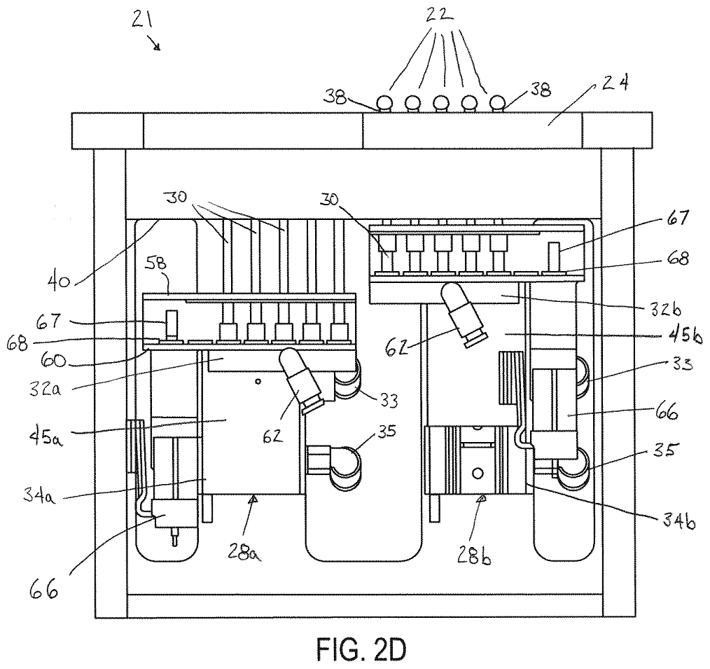

The present invention will now be described with reference to the accompanying figures, wherein the numbered elements in the following written description correspond to like-numbered elements in the figures. A high-speed lyophilized bead handling system or assembly 20 is shown in FIGS. 1A-1E for handling and moving spherical beads 22 (FIG. 2C) in accordance with aspects of the present invention. In the illustrated embodiment beads 22 are lyophilized beads. Although discussed below in connection with lyophilized beads 22, it should be appreciated that handling system 20 may be used with beads constructed of alternative materials and for alternative purposes.

Handling assembly 20 includes a bead lifting assembly 21 that includes a bead container 24 comprising an internal reservoir 26 within which multiple lyophilized beads 22 are contained in a loose arrangement. As discussed in more detail below, bead lifting assembly 21 includes a pair of reciprocating lifts or lift assemblies 28a, 28b each of which include multiple vacuum stems or tubes 30 that interact with container 24 for selectively obtaining beads 22 from the interior of reservoir 26 and are then moved outwardly from the interior volume of reservoir 26, which in the illustrated embodiment entails lifting the beads upwardly on the tubes 30, whereby each of the beads 22 are presented and positioned in a known arrangement or orientation. Each of the beads 22 may then be selectively picked from the tubes 30 by separate equipment, such as pick-and-place machine 23 to pick the beads 22 from the tubes 30 and place each of the beads 22 elsewhere. For example, and as discussed in more detail below, each of the beads 22 may be placed on or into individual cartridges within or into which a liquid is added for reconstituting the material of the bead. In such a situation the cartridge may then be used as a consumable medical test device.

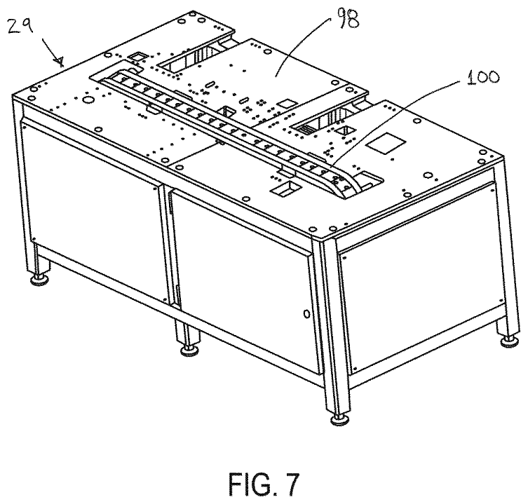

In addition to bead lifting assembly 21 and pick-and-place machine 23, and as also discussed below, handling assembly 20 includes a feeder 25 for automatically providing beads 22 into container 24, as well as a vision system 27 for use in inspecting beads 22 when supported on tubes 30. Handling assembly 20 may also include or be incorporated with a work station 29 (FIG. 7) that comprises a conveyor station that brings items to handling assembly 20 for receiving beads 22 from pick-and-place equipment 23 and subsequently transports the items elsewhere, such as part of a production or packaging process.

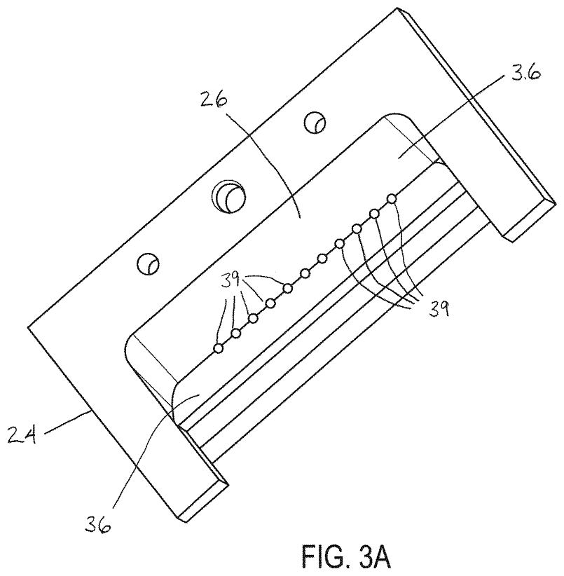

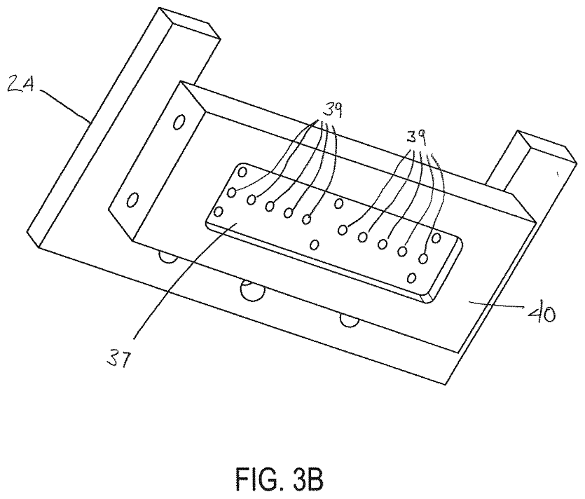

With further reference to FIGS. 2A-2D, in the illustrated embodiment of bead lifting assembly 21 each lift assembly 28a, 28b includes five vacuum tubes 30 mounted to vacuum heads 32a, 32b, respectively, that are mounted to actuators 34a, 34b for raising and lowering the vacuum heads 32a, 32b, respectively. The tubes 30 of each vacuum head 32a, 32b are configured to undergo reciprocating movement within the internal reservoir 26 of container 24. The internal reservoir 26 forms or defines an elongated V-shaped cavity by opposed angled walls 36 (FIG. 3A). The angled walls 36 lead to an elongate internal bottom 37 at which the beads 22 congregate via gravity for engagement with ends 38 of tubes 30 when the tubes 30 are retracted. The tubes 30 may reciprocate through apertures, such as individual holes 39 in the base 40 of container 24 (FIGS. 3A-3B). For example, actuators 34a, 34b and tubes 30 may be sized whereby the stroke of the actuators 34a, 34b retracts the ends 38 of tubes 30 downward so that the ends 38 are at or near or below the internal surface of the elongate bottom 37 of the reservoir 26. Correspondingly, the stroke of actuators 34a, 34b and the length of tubes 30, along with the height of container 24, are sized whereby when tubes 30 are extended upwards the beads 22 are presented for picking by pick-and-place equipment 23. Alternatively, base 40 of container 24 may include slots.

Actuators 34a, 34b may be constructed as pneumatic, electric or hydraulic actuators. In the illustrated embodiment, actuators 34a, 34b comprise pneumatic slide actuators and include one or more extendable and retractable arms or pistons 42 and a main body or housing 44 from which the arms 42 extend and retract. Each actuator 34a, 34b includes fittings 33, 35 that are configured as air inlets and outlets for actuating pistons 42 via airlines (not shown) connected to fittings 33, 35. Pistons 42 are connected to a slide block 43 that is mounted for movement with body 44. In turn, guide blocks 45a, 45b are mounted to the respective slide blocks 43, where guide blocks 45a, 45b support respective vacuum heads 32a, 32b (FIGS. 2A, 2C, 2D).

In the illustrated embodiment the actuators 34a, 34b of each lift assembly 28a, 28b are alternatively extended and retracted, by extension and retraction of the respective arms 42, whereby the respective vacuum heads 32a, 32b are alternatively raised and lowered in opposite timing to each other. For example, as understood from FIG. 2D, actuator 34b of lift assembly 26b is shown in an extended orientation whereby ends 38 of tubes 30 of vacuum head 32b with beads 22 are extended from reservoir 26 to enable picking of the beads 22 from the tubes 30. Correspondingly, actuator 34a of lift assembly 26a is shown in a retracted orientation whereby ends 38 of tubes 30 of vacuum head 32a are able to engage beads 22 from within reservoir 26. Upon the beads 22 being picked from the tubes 30 of vacuum head 32b, actuator 34b is retracted to draw the ends 38 of tubes 30 into reservoir for engaging additional beads 22, while correspondingly actuator 34a is raised whereby beads 22 that have been engaged by tubes 30 when vacuum head 32a was in the retracted position are subsequently extended from reservoir 24 whereby such beads 22 may then be picked from the tubes 30 of vacuum head 32a. In this manner a continuous supply of beads 22 may be presented for picking by the pick-and-place equipment. In the illustrated embodiment, lift assembly 28a is shown to be fully retracted at the same time that lift assembly 28b is fully extended. It should be appreciated that lift assemblies 28a, 28b need not operate in exactly opposite timing from one another with bead handling assembly 20 still operating as intended within the scope of the present invention. That is, the lift assemblies 28a, 28b may operate asynchronously and still function to provide a continuous supply of beads 22. For example, tubes 30 associated with lift 28a may be fully raised with beads 22 on tubes 30 prior to the complete removal of the beads 22 from tubes 30 of lift 28b. This is shown in FIGS. 1A-1C and FIGS. 2A-2C for illustrative purposes only. Correspondingly, upon completion of the removal of beads 22 from tubes 30 of lift 28b, the actuator 34b may retract and extend the tubes 30 to present beads 22 for removal prior to completion of the removal of beads 22 from the tubes 30 of lift 28a.

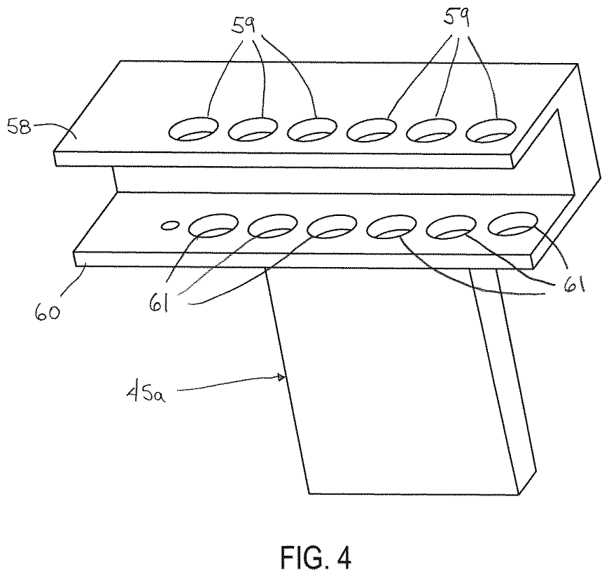

Guide block 45a is illustrated in FIG. 4, with guide block 45b being a mirror image of guide block 45a. As shown in FIG. 4, guide block 45a includes a pair of spaced apart arms 58, 60 that include aligned openings 59, 61, respectively. Tubes 30 are mounted between arms 58, 60 at openings 59, 61 with tubes 30 extending up and through openings 59. Although lift assembly 28a includes five tubes 30, guide block 45a in the illustrated embodiment includes six pairs of aligned holes 59, 61 and thus may accommodate six tubes 30 if desired. It should be appreciated that alternative numbers of tubes 30 may be used with each lift assembly, including more or less than five or six and need not include an equal number on each lift. Vacuum head 32a is mounted to the underside of lower arm 60 so as to selectively provide a vacuum to tubes 30 through lower arm 60.

With reference to FIG. 3, vacuum tubes 30 are configured as cylindrical tubes in the illustrated embodiment to form a circular opening at ends 38 for engagement with spherical beads 22, where tubes 30 may be made from hypodermic tubing. Vacuum heads 32a, 32b each include a fitting 62 to which moveable vacuum lines (not shown) are connected for providing suction to each of the vacuum heads 32a, 32b and, in turn, tubes 30, such as from a vacuum pump (not shown). System 20 may include one or more controllers 64 for coordinating the extension and retraction of actuators 34a, 34b, as well as for drawing air through vacuum heads 32a, 32b and/or tubes 30, as well as for coordinating movement of pick-and-place machine 23. For example, a controller may selectively cause a vacuum pump to draw air through tubes 30 when tubes 30 are in the fully retracted position so as to attract or cause beads 22 within container 24 to engage with the ends 38 of tubes 30. The vacuum created by the drawn air may then continue to be applied while the tubes 30 are raised to their fully extended position. Still further, the vacuum holding the beads 22 may then be turned off, such as at or just prior to the bead 22 being removed by the pick-and-place equipment, with the vacuum being discontinued until the tubes 30 have returned to their fully retracted position. The pick-and-place machine 23 may correspondingly operate to handle individual beads 22 by a vacuum operated by such a controller. In the illustrated embodiment the vacuum within tubes 30 associated with a given vacuum head 32a, 32b may all simultaneously be controlled to turn on or off together via vacuum heads 32a, 32b. Alternatively, vacuums within tubes 30 may be individually controlled. Vacuum heads 32a, 32b may include valves as well as a suction or vacuum generator, or may operate as a manifold as shown with the vacuum being created by a separate device and a vacuum line extending to the vacuum heads 32a, 32b. Alternatively, a vacuum or air draw may continuously be applied through tubes 30 during the entire extension and retraction cycle, with the pick-and-place machine 23 having a greater pick force, such as via its own vacuum or a mechanical engagement of beads 22 to remove the beads 22 from the tubes 30.

Tubes 30 are also rotatable for inspection of beads 22 by vision system 27. Each lift 28a, 28b includes a drive motor 66 comprising an electric drive that is mounted to respective ones of the guide blocks 45a, 45b for up and down movement with the guide blocks 45a, 45b via actuators 34a, 34b. with reference to FIG. 2C, each electric motor 66 is provided with a gear 68 comprising a drive gear mounted to a drive shaft 67 of the motor 66 and each tube 30 is fitted with a gear 70 comprising a driven gear, where in the illustrated embodiment an additional gear 70 is disposed between and engaged with the drive gear 68 and correspondingly engaged with the gear 70 of the closest adjacent tube 30. Gears 70 of tubes 30 may be mounted via bearings 72 (as shown in regard to lift 28a), with seals such as o-rings or the like used to provide a seal therewith relative to vacuum heads 32a, 32b. Alternatively, as shown with regard to lift 28b bearings 72 may be disposed adjacent arm 58 of guide block 58b, with gears 70 being sealed relative to the guide block 58b in like manner. Drive gear 68 may either be meshed with the adjacent driven gear 70, with the driven gears 70 in turn meshed together. Alternatively, gear 68 may drive by a belt about the gears 70, such as serpentine around the gears 70. Accordingly, rotation of the drive shaft 67 of drive motor 66 imparts rotation to the tubes 30 whereby the beads 22 held on each of the ends 38 of tubes 30 are rotated 360 degrees to enable inspection of the exterior surface of the spherical beads by vision system 27, as discussed in more detail below. In the case of intermeshing of the gears 68, 70 or a serpentine drive belt, rotation of the drive shaft 67 of drive motor 66 imparts rotation to the tubes 30, with adjacent tubes 30 rotating in opposite directions relative to each other.

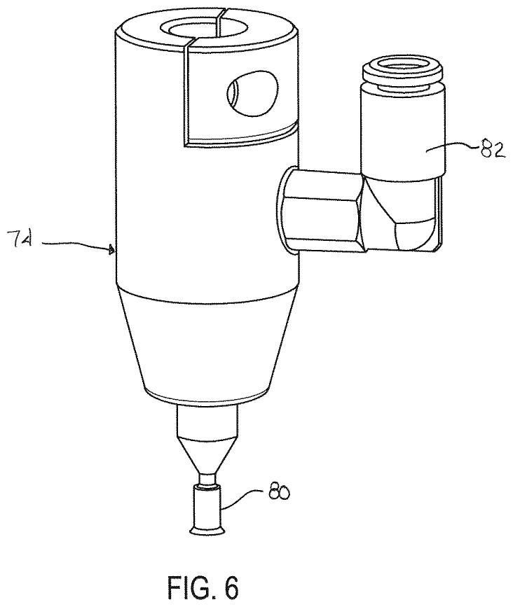

An exemplary pick-and-place machine 23 is shown in FIGS. 1A-1E and includes a suction pick-and-place head 74 (FIG. 6) that is mounted to a robotic arm 76 of a multi-axis robot 78 for selective movement of suction head 74. In the illustrated embodiment robot 78 is a selective compliance articulated robot (SCARA) provided by Epson America, Inc., but may be alternatively configured. Suction head 74 includes a nozzle 80 that is configured to be selectively positioned above the beads 22 as presented for removal, with suction head 74 actuating a vacuum through nozzle 80 for engaging a bead 22, where nozzle 80 may include a conically shaped interior end for contacting bead 22 sized relative to the diameter of the bead 22. The vacuum through nozzle 80 is applied through suction head 74 via a fitting 82 connected to a vacuum line (not shown) connected to an air pump (not shown) that may generate a vacuum and/or provide low pressure air, which may be the same pump as used for vacuum heads 32a, 32b or may be another pump. Arm 50 is then moved to position head 74 and nozzle 80 to a location for placement of bead 22, such as for subsequent processing or packaging as discussed below. Upon positioning head 74 and nozzle 80 where desired, the vacuum through nozzle 80 may be discontinued to allow the bead 22 to drop by gravity, or a slight puff of positive pressure may be applied to discharge bead 22. The control of air through suction head 74 may be provided by controller 64 or another controller. Although shown in connection with a single robotic arm 76, head 74 and nozzle 80, it should be appreciated that depending on the requirements or needs of the system multiple robotic arms, heads and nozzles may be employed. Still further, a vacuum head may include multiple nozzles for simultaneously grasping multiple beads 22.

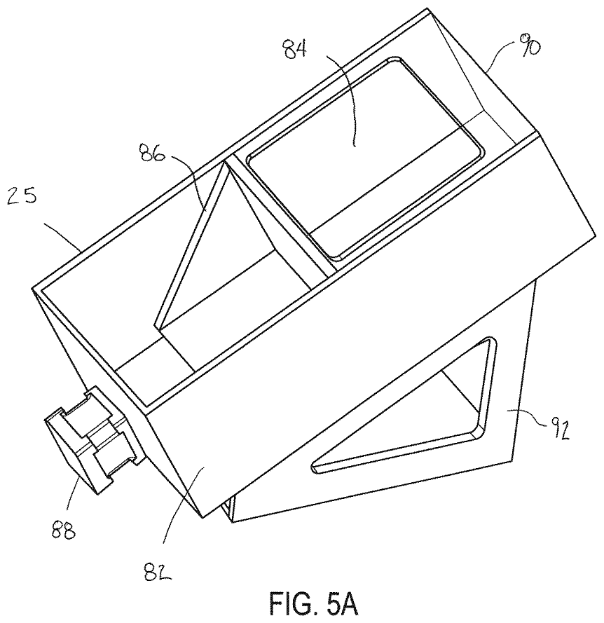

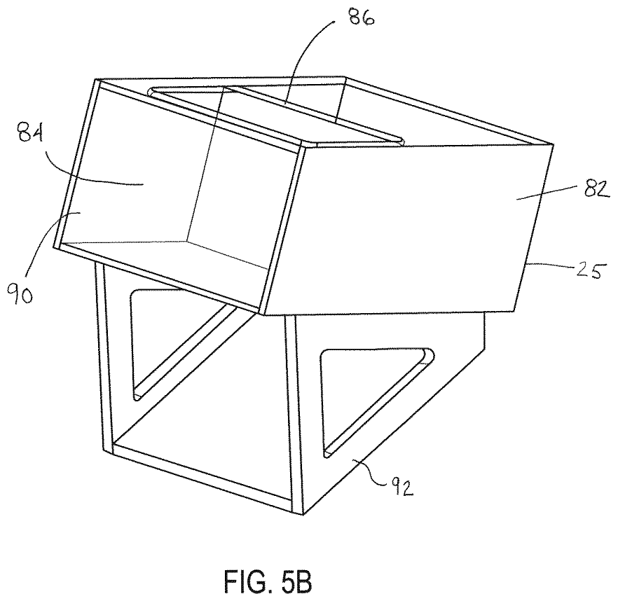

Bulk feeder or hopper feeder 25, as shown in FIGS. 1A-1E and FIGS. 5A and 5B, is used to provide additional beads 22 into container 24 as the supply of beads 22 therein is depleted. Feeder 25 comprises a housing 82 defining a chamber 84 into which beads 22 are placed and a slide 86 that is moveable by an actuator 88 to push beads 22 out of chamber 84 through opening 90 in housing 82 to drop into reservoir 26 of container 24, with housing 82 being held at an angle via a support 92. A level sensor, such as configured as a laser or light sensor, or as a camera, or the like, may be used to monitor the amount of beads 22 within container 24. Upon detecting that the amount of beads 22 has decreased to a level at which replenishment is desired, the bulk feeder 25 may subsequently discharge additional beads 22 into reservoir 26, such as via controller 64 activating actuator 88 to drive slide 86. The bulk feeder may be alternatively configured in any of a number of ways to supply beads 22, for example, by a step feeder having a belt with ribs to selectively insert metered amounts of beads 22 into reservoir 26, or by a rotational feed wheel with partitioned sections with a selective opening that allows beads 22 to be deposited into reservoir 26 when rotated into the correct orientation. Still further, an air handling system may be employed for providing beads from the feeder to the container 24.

With reference to FIGS. 1A, 1C and 1E, system 20 may further include a vision system 27 comprising one or more cameras 94, where in the illustrated embodiment camera 94 is supported by a stand or arm 96. Vision system 27 via camera 94 may be used to examine or inspect the beads 22 that are raised into the removal position as shown in FIGS. 2C and 2D. Vision system 27 may be used to confirm the presence of a bead 22 on a given tube 30, as well as monitor the removal of the bead 22 therefrom, including potentially confirming the placement of the bead 22. Vision system 27 may additionally or alternatively be used for inspecting beads 22 to confirm conformance with predesignated standards, including for example inspecting whether a given bead contains defects, such as chips or cracks, and/or inspecting the size of beads 22, and/or inspecting the type of bead, such as by color or other designator. System 20 may further include a discharge receptacle (not shown), such as for example near or adjacent container 24, such as a bin or the like, into which pick-and-place head 74 may deposit or discharge non-conforming beads 22.

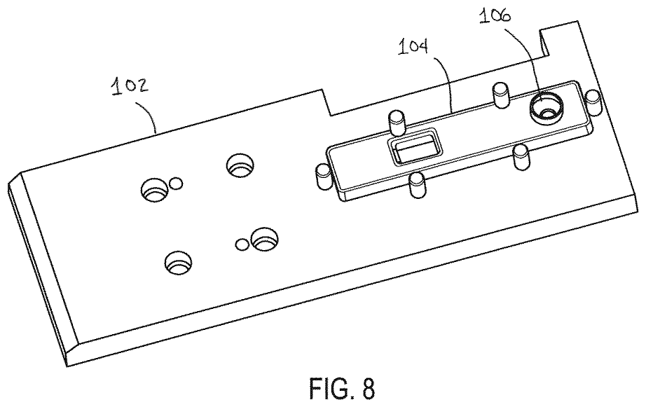

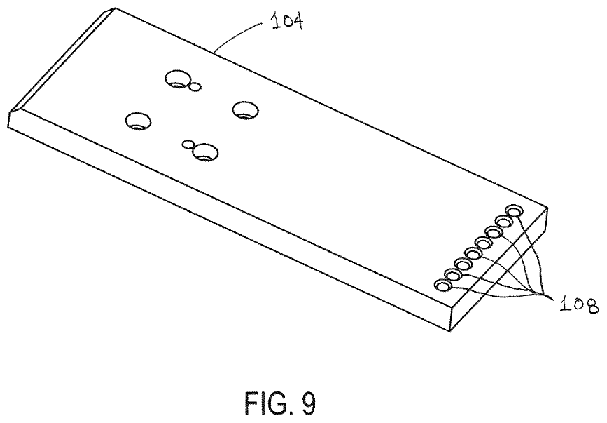

With reference to FIG. 7, system 20 may be incorporated with or include a work station 29, such as by system 20 being mounted at the illustrated conveyor station. For example, by being mounted to a surface 98 of station 29. Conveyor station 29 includes a conveyor 100 comprising a track that is operable to transport trays 102, 104 (FIGS. 8 and 9) to and from proximate pick-and-place machine 23 whereby robot arm 76 is able to move a bead 22 selected by head 74 from a tube 30 to a given tray 102, 104. To this end, it should be appreciated that arm 76 is extendable and retractable in a vertical orientation.

With reference to FIG. 8 a tray 102 is illustrated that includes a medical test cassette 104 mounted thereon, with cassette 104 including a receptacle 106 into which suction head 74 may place a selected bead 22, such as by terminating the vacuum at nozzle 80 or by providing a puff of air. Tray 102 is then moveable along conveyor 100 whereby cassette 104 with the bead 22 deposited therein may be picked and placed by separate equipment (not shown) for subsequent processing or packaging, and where another cassette 104 may be provided on the tray 102. With reference to FIG. 9, tray 104 includes a plurality of receptacles 108 that may receive beads 22 for transporting to another location for subsequent packaging or processing. It should be understood that numerous alternative equipment and techniques may be used for subsequent handling, packaging and/or processing of beads 22 post system 20.

It should be appreciated that lyophilized bead handling assembly 20 may be alternatively constructed compared to that show in FIGS. 1 and 2 and still operate as intended within the scope of the present invention. For example, although shown as including five tubes 30 with each vacuum head 32a, 32b, more or fewer than five tubes for each reciprocating assembly may be provided. In addition, although illustrated as including two lift assemblies 28a, 28b, an alternative material handling assembly may be configured to include more than two such lift assemblies. For example, an alternative lyophilized bead handling assembly may include three or more lift assemblies, each of which extends and retracts one or more vacuum tubes. Moreover, an alternative assembly may include more than one container or internal reservoirs, such as may be formed by a segmented bead reservoir. For example, a divider may be placed in the container 24 shown above to create two internal reservoirs whereby each lift assembly 28a, 28b is associated with a separate internal reservoir. In such situation each reservoir may contain a different type of bead, such as may be used for test configurations requiring multiple assays. Still further, alternative configurations and operations may be provided other than as shown with respect to actuators 34a, 34b being configured to lift beads 22 vertically upwards through extension of arms 42. For example, tubes 30 may be extended and retracted in an alternative orientation, such as to lift beads 22 at an angle relative to horizontal other than a perpendicular angle. Still further, system 20 may be used with different sized beads, including using different diameter tubes and differently sized nozzles. Tubes 30 may be removable from guide blocks 45a, 45b for either repair or using with alternatively sized tubes and/or guide blocks 45a, 45b may be removable together for configuring system 20 with differently sized beads.

Other changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A bead handling system comprising:
a first lift assembly and a second lift assembly, wherein each of the first and second lift assemblies comprise an actuator and at least one vacuum tube for selectively engaging with a bead;
wherein the actuators of the first and second lift assemblies are configured to extend and retract their respective vacuum tube for selective engagement with a bead and selective positioning of the engaged bead into a known position, and wherein the actuators of the first and second lift assemblies are not simultaneously extended and retracted together in unison.

2. The handling system of claim 1, wherein the actuators of the first and second lift assemblies are extended and retracted oppositely from one another.

3. The handling system of claim 1, wherein the vacuum tube of each of the first and second lift assemblies are configured to engage a bead when retracted, and wherein the vacuum tube of each of the first and second lift assemblies positions an engaged bead into a known position when in the extended position.

4. The handling system of claim 1, wherein each of the first and second lift assemblies comprise a plurality of vacuum tubes.

5. The handling system of claim 1, further comprising a container for beads, and wherein the vacuum tube of the first lift assembly is configured to extend from an internal volume of the container and retract into the internal volume of the container.

6. The handling system of claim 5, wherein the vacuum tube of the first second lift assembly is configured to extend from the internal volume of the container and retract into the internal volume of the container.

7. The handling system of claim 6, wherein the actuators of the first and second lift assemblies are disposed beneath the container.

8. The handling system of claim 7, wherein the actuators of the first and second lift assemblies are configured to vertically extend and retract their respective vacuum tubes.

9. The handling system of claim 1, further comprising a camera system configured to image beads when positioned in the known position.

10. The handling system of claim 9, wherein the vacuum tubes of the first and second lift assemblies are configured to rotate when extended in the known position.

11. The handling system of claim 1, further comprising a moveable suction head, wherein said moveable suction head is configured to selectively remove beads from the vacuum tubes when in the known position.

12. A method of handling beads using a material handling system having a first actuator coupled with at least one vacuum tube and a second actuator coupled with at least one vacuum tube, said method comprising:
extending and retracting the first actuator to selectively engage a bead with the tube coupled to the first actuator and selectively position the engaged bead into a known position; and
extending and retracting the second actuator to selectively engage a bead with the tube coupled to the second actuator and selectively position the engaged bead into a known position;
wherein the actuators of the first and second lift assemblies are not simultaneously extended and retracted together in unison.

13. The method of claim 12, wherein the first and second actuators are extended and retracted oppositely from one another.

14. The method of claim 12, wherein the vacuum tube coupled to each of the first and second actuators engage a bead when retracted, and wherein the vacuum tube coupled to each of the first and second actuators positions an engaged bead into a known position when in the extended position.

15. The method of claim 12, wherein a plurality of vacuum tubes are coupled to each of the first and second actuators.

16. The method of claim 12, further comprising a container for beads, and wherein the vacuum tube coupled to the first actuator is configured to extend from an internal volume of the container and retract into the internal volume of the container.

17. The method of claim 16, wherein the vacuum tube coupled to the second actuator is configured to extend from the internal volume of the container and retract into the internal volume of the container.

18. The method of claim 17, wherein the first and second actuators are disposed beneath the container.

19. The method of claim 12, further comprising imaging with a camera a bead disposed on one of the vacuum tubes.

20. The method of claim 19, further comprising rotating the vacuum tube while the bead is disposed thereon.
